(19) United States
(12) Patent Application Publication
(10) Pub. No.: US 2012/0263912 A1
(43) Pub. Date: Oct. 18, 2012

(54) ONE-PIECE CONTAINER SLEEVE

(76) Inventor: SCOTT SANDERS, Moreland Hills, OH (US)

(21) Appl. No.: 13/212,292

(22) Filed: Aug. 18, 2011

Related U.S. Application Data
(60) Provisional application No. 61/475,383, filed on Apr. 14, 2011.

(51) Int. Cl. B32B 3/06

(52) U.S. Cl. 428/99

(57) ABSTRACT

A container sleeve designed to be fitted about a beverage container and formed of a single piece of material. The container sleeve includes a first body portion, a second body portion, a first connector and a second connector. The top edges of the body portions facing one another prior to the container sleeve being formed for fitting about the beverage container. The top edges defining a top opening of the container sleeve when the container sleeve is formed for fitting about the beverage container. The first connector is integrally connected to the first side edges of the first and second body portions and the second connector is integrally connected to the second side edges of the first and second body portions.

The present invention claims priority on U.S. Provisional Application Ser. No. 61/475,383 filed Apr. 14, 2011 and U.S. Design Pat. application Ser. No. 29/389,894 filed Apr. 18, 2011, both of which are incorporated herein by reference.

The present invention is directed to a container sleeve, more particularly to a one-piece container sleeve, and even more particularly to a container sleeve that is fit at least partially about a container to at least partially insulate a liquid in the container, to at least partially provide insulation between the container and a user's hand, to facilitate in the handling of the container, to alter and/or improve the look and/or aesthetics of the container, and/or to provide markings, wording, logos, and/or various types of marketing and/or advertising material on the container.

### BACKGROUND OF THE INVENTION

Many disposable cups and container are used for holding hot beverages such as, but not limited to, coffee, espresso, cappuccino, latte, tea, warm milk, and hot chocolate. These disposable cups or containers can also be used to hold various types of food items such as, but not limited to, soup, chili, noodle containing items, rice, etc. These disposable cups or containers often allow heat from the beverage or food item to transfer to a person's hand through a holding surface of the cup or container. If the holding surface gets too hot, it can make holding the disposable cup or container uncomfortable. If the user holds the disposable cup or container with his or her finger by a narrow margin so as to avoid the heat, the user may drop the disposable cup or container, and the user may suffer scalding due to spilled coffee. Similar problems exist when holding very cold beverages (e.g., iced coffee, iced tea, slush drinks, frozen drinks, etc.) or cold food items (e.g., ice cream, etc.).

Often a container sleeve is used to reduce the heat/cold felt by a user by insulating the user from some of the heat/cold on the holding surface of the container. The container sleeve forms an insulating layer on the sidewall of the container to reduce/eliminate somewhat the heat/coldness of the container.

Although there are many different container sleeves available in the prior art (e.g., U.S. Pat. No. 4,548,349; U.S. Pat. No. 5,205,473; U.S. Pat. No. 5,209,367; U.S. Pat. No. 5,385,260; U.S. Pat. No. 5,425,497; U.S. Pat. No. 5,445,315; U.S. Pat. No. 5,454,484; U.S. Pat. No. 5,669,553; U.S. Pat. No. 5,826,786; U.S. Pat. No. 5,842,633; U.S. Pat. No. 5,857,615; U.S. Pat. No. 6,152,363; U.S. Pat. No. 6,286,754; U.S. Pat. No. 6,343,735; U.S. Pat. No. 6,986,438; US 2011/0068114; US 2010/0213205; US 2010/0200603; US 2010/0025414; US 2009/0050767; US 2003/0111475), there remains a need for a simple, reduced-cost container sleeve.

### SUMMARY OF THE INVENTION

The present invention is directed to a container sleeve that is simple to use and can reduce the cost of manufacture of the container sleeve. The container sleeve is designed to fit at least partially about a container to at least partially insulate a liquid in the container and/or insulate a user's hand from the surface temperature of the container. The container sleeve can also be used to facilitate in insulating the beverage or food item in the container, to facilitate in the handling of the container, to alter and/or improve the look and/or aesthetics of the container, and/or to provide markings, wording, logos, and/or various types of marketing and/or advertising material on the container.

In one non-limiting aspect of the invention, the container sleeve is formed of a single piece of material. Generally the material is formed of one type of material; however, this is not required. The material is generally a durable and flexible or bendable material (e.g., paper material, cellulose material, certain metal materials, certain polymer materials, certain composite material, etc.); however, this is not required. In one non-limiting embodiment of the invention, the container sleeve is formed of a biodegradable or semi-biodegradable material. One non-limiting design, the biodegradable or semi-biodegradable material is a paper or cellulose material such as, but not limited to paper board, cardboard, corrugated paper board, corrugated cardboard, and the like. When a paper or cellulose material is used, the weight of the paper or cellulose material is generally about 4-200 lb. (per thousand square feet) material; however, other material weights can be used. The paper or cellulose material generally has a thickness of about 0.01-0.2 inches; however, other thickness can be used. When a corrugated material is used, the corrugated material can be an F-flute (commonly referred to as a micro-flute) or E-flute material; however, other flute profiles can be used. The paper or cellulose material can be optionally coated with a material that reduces or eliminates moisture absorption; however, this is not required. The container sleeve can be formed of one or more pieces of corrugated material; however, this is not required. When corrugated material is used, one or both sides of the corrugated material can secured to a generally flat or planar material (e.g., paper board material, etc.); however, this is not required. When a coating is used, the coating can be a poly-coated material (e.g., Low Density Polyethylene (LDPE) Resins, Linear Low Density Polyethylene (LLDPE) Resins, Ultra Low Density Polyethylene (ULDPE) Resins, etc.); however, it can be appreciated that other or additional coating materials can be used.

In another and/or alternative aspect of the present invention, the container sleeve is fully formed or cut from a single piece of material. In one non-limiting embodiment, the container sleeve is cut by cutting dies or other types of cutters; however, this is not required. In one non-limiting method, a single generally flat piece of material (e.g., paper board, cardboard, corrugated material, etc.) is cut by a cutting die to fully form the container sleeve. After the container sleeve is cut, the top surface of the container sleeve lies generally in a single plane. Furthermore, the bottom surface of the container sleeve also generally lies in a single plane and such plane is generally parallel to the plane of the top surface of the container sleeve. When the piece of the material that is cut into the container sleeve is a non-smooth material (e.g., ribbed material, etc.), the top plane of the non-smooth surface generally lies in a flat top plane, and such flat top plane is generally parallel to the bottom flat plane of the container sleeve after the container sleeve has been cut. Once the container sleeve is cut or formed, the container sleeve does not require an adhesive to connect the ends or any other portion of the container sleeve together prior to being used on a container. Likewise, the container sleeve does not require an adhesive to connect container sleeve to a container. Furthermore, after the container sleeve is formed or cut form a single piece of material, the ends or any other portion of the container sleeve do not need to be connected together prior to being used on a container. As such, the container sleeve of the present invention is a significant improvement over prior art container sleeves. When corrugated material is used, the material can include the corrugated fluting on one outside surface of the material; however, this is not required. When the corrugated fluting is on the outside of the material, the container sleeve can be designed such that the corrugated fluting is facing the container when the container sleeve is placed on the container, or faces outwardly from the container when the container sleeve is placed on the container. As can be appreciated, the corrugated material can include fluting on both sides of the material.

In still another and/or alternative aspect of the present invention, the container sleeve includes a first body portion, a second body portion, and first and second connectors tabs that are integrally formed with the first and second body portions. In one non-limiting embodiment of the invention, the first and second body portions have generally the same size and shape; however, this is not required. In another and/or alternative non-limiting embodiment of the invention, the first and second connectors have generally the same size and shape; however, this is not required. Each of the body portions include a top edge and first and second side edges. In still another and/or alternative non-limiting embodiment of the invention, the top edges of the first and second body portions face one another prior to the container sleeve being configured for fitting onto a container. For example, after the container sleeve is cut from a single piece of material, when the container sleeve is formed by a cutting process, the top edges of the first and second body portions are facing one another after the cutting process. In one non-limiting arrangement, the top edges of the first and second body portions are both facing one another and are generally parallel to one another prior to the container sleeve being configured for fitting onto a container. In still another and/or alternative non-limiting embodiment of the invention, the first connector is connected to the first side edges of the first and second body portions, and the second connector is connected to the second side edges of the first and second body portions. Each of the connectors are connected on both sides of the top edges of the first and second body portions. In one non-limiting arrangement, two connectors are not adhesively connected to the first and second body portions, or otherwise mechanically connected (e.g., staple, latching arrangement, slot arrangement, hook and loop fastener, etc.) to the first and second body portions. The two connectors are integrally formed with the two body portions. As such, the two connectors are never separated from the two body portions during the formation of the container sleeve and when the container sleeve is inserted onto a container. In yet another and/or alternative non-limiting embodiment of the invention, the two connectors are generally not connected to the complete side edge of the first and second body portions. In one non-limiting arrangement, The first connector is connected to about 2%-75% of the length of the first side edge of the first body portion and 2%-75% of the length of the first side edge of the second body portion. Likewise, second connector is connected to about 2%-75% of the length of the second side edge of the first body portion and 2%-75% of the length of the second side edge of the second body portion. As can be appreciated, one or both connectors can be connected to more than 75% of the one or both of the side edges of the first and/or second body portions. In another and/or alternative non-limiting arrangement, one or both connectors are connected to generally the same amount of the side edge of one or both side edges of the first and/or second body portions. In such an arrangement, each of the connectors can be generally centered about the oppositely facing top edges of the first and second body portions; however, this is not required.

In yet another and/or alternative aspect of the present invention, the two connectors on the container sleeve extend outwardly from the side edges of the first and second body portions. In one non-limiting embodiment of the invention, the two connectors extend outwardly from the side edges of the first and second body portions a distance that is about 2%-25% the largest width of the first or second body portion. The shape and configuration of the two connectors can be used to facilitate in holding and/or grasping the container sleeve when positioned on the container, or function as a friction engagement to maintain the sleeve on a container.

In still yet another and/or alternative aspect of the present invention, the container sleeve can optionally include one or more configuration arrangements such as, but not limited to, grooves, slots, notches, serrated regions or the like to facilitate in the bending and forming of the container sleeve prior to placing the container sleeve on a container. Generally, the one or more configuration arrangements are formed prior to, during, or after the cutting or forming of the container sleeve from the one piece material. In one non-limiting embodiment of the invention, the container sleeve includes a serrated region between the two front edges of the first and second body portions; however, this is not required. The serrated region is used to enable the container sleeve to be bent along the serrated region when forming the container sleeve to be fitted onto a container and/or to facilitate in separating the front edges of the two body portions from one another when forming the container sleeve to be fitted onto a container. In another and/or alternative one non-limiting embodiment of the invention, the container sleeve includes a grooved, slotted and/or notched arrangement between the two front edges of the first and second body portions; however, this is not required. The grooved, slotted and/or notched arrangement is used to enable the container sleeve to be bent along the grooved, slotted and/or notched arrangement when forming the container sleeve to be fitted onto a container and/or to facilitate in separating the front edges of the two body portions from one another when forming the container sleeve to be fit onto a container. In still another and/or alternative one non-limiting embodiment of the invention, the container sleeve includes a grooved, slotted and/or notched arrangement between one or both connectors and one or both side edges of the first and second body portions; however, this is not required. The grooved, slotted and/or notched arrangement is used to enable the container sleeve to be bent along the grooved, slotted and/or notched arrangement when forming the container sleeve to be fitted onto a container. In yet another and/or alternative one non-limiting embodiment of the invention, the container sleeve includes a grooved, slotted and/or notched arrangement on one or both connectors; however, this is not required. One or more grooved, slotted and/or notched arrangements can exist on one or both connectors. The one or more grooved, slotted and/or notched arrangements can be used to enable the container sleeve to be bent along the grooved, slotted and/or notched arrangement when forming the container sleeve to be fitted onto a container. In still yet another and/or alternative one non-limiting embodiment of the invention, the container sleeve includes a grooved, slotted and/or notched arrangement on one or both body portions; however, this is not required. One or more grooved, slotted and/or notched arrangements can exist on one or both body portions. The one or more grooved, slotted and/or notched arrangements can be used to enable the container sleeve to be bent along the grooved, slotted and/or notched arrangement when forming the container sleeve to be fitted onto a container.

In another and/or alternative aspect of the present invention, the container sleeve can optionally include a cut-out portion that is positioned between two front edges of the first and second body portions; however, this is not required. The shape of the cut-out portion is non-limiting. In one non-limiting arrangement, the cut-out portion is oval shaped or circular shaped. In another and/or alternative non-limiting arrangement, one or more sections of the cut-out portion have an arcuate shape. The cut-out portion can be used to enable the container sleeve to be bent about the cut-out portion when forming the container sleeve to be fitted onto a container and/or to facilitate in further separating the front edges of the two body portions from one another when forming the container sleeve to be fitted onto a container.

In still another and/or alternative aspect of the present invention, the container sleeve can optionally include one or more openings positioned on or closely adjacent to the first connector and/or the second connector. The one or more openings, when used, are designed to inhibit or prevent tearing of at least one of the connectors when the container sleeve is formed for positioning about the container. The one or more openings are generally positioned along a dividing axis of the container sleeve; however, this is not required. The dividing axis is the axis that is positioned between the top edges of the first and second body portion. When the first and second portions are connected together by a serrate region or one or more spaced slots, the dividing axis is generally positioned on the serrated or slotted region. When the first and second body portions have generally the same length, the dividing axis is the same as the central horizontal axis of the container sleeve. The dividing or central horizontal axis runs generally normal or perpendicular to the central longitudinal axis of the container sleeve; however, this is not required. The shape of the one or more openings is non-limiting. Generally, the opening has a circular or oval shape; however, other shapes can be used (e.g., square, polygonal, etc.). In one non-limiting embodiment, the cut slot or serrated region between the top edges of the body portions terminate at or closely adjacent to an opening. An opening can exist at each of the two ends of the cut slot or serrated region between the top edges of the body portions. The one or more openings are generally partially or fully positioned in the one or both connectors. Generally, a majority of at least one opening is encircled by one of the connectors, typically at least 60% of at least one opening is encircled by one of the connectors, more typically at least 75% of at least one opening is encircled by one of the connectors, still more typically at least 80% of at least one opening is encircled by one of the connectors, yet still more typically at least 90% of at least one opening is encircled by one of the connectors, even still more typically at least 95% of at least one opening is encircled by one of the connectors, and yet even still more typically about 98-100% of at least one opening is encircled by one of the connectors.

In still yet another and/or alternative aspect of the present invention, the container sleeve can optionally include printed material on the outside surface of the container sleeve. The printed information can be used to a) provide product information, b) provide advertising and/or marketing information, c) improve, enhance, and/or change the aesthetics of the container sleeve or the container that includes the container sleeve, and/or d) provide a medium for coupons, games, and the like.

In summary, one non-limiting embodiment of the invention is directed to a container sleeve designed to be fitted about a beverage container and formed of a single piece of material. The container sleeve includes a first body portion, a second body portion, a first connector and a second connector. The first and second body portions include a top edge and first and second side edges. The top edges of the body portions face one another prior to the container sleeve being formed for fitting about the beverage container. The top edges define a top opening of the container sleeve when the container sleeve is formed for fitting about the beverage container. The first connector is integrally connected to the first side edges of the first and second body portions and the second connector is integrally connected to the second side edges of the first and second body portions. The container sleeve does not include an adhesive or other type of mechanical connector to fully form the container sleeve for insertion about a container. In one non-limiting embodiment of the invention, only said two connectors connect together the first and second body portions. In another and/or alternative non-limiting embodiment of the invention, the first and second connectors extend outwardly from the side edges of the first and second body portions. The two connectors are generally the same shape and size. In another and/or alternative non-limiting embodiment of the invention, the first and second connectors include a groove along a longitudinal length of the connectors. The groove is designed to facilitate in bending the connectors along the grooves when the container sleeve is formed for fitting about the beverage container. In another and/or alternative non-limiting embodiment of the invention, the first and second body portions include a plurality of grooves that are normal to a longitudinal axis of the first and second body portions. The grooves are designed to facilitate in bending the first and second body portions about the container when the container sleeve is formed for fitting about the beverage container. In another and/or alternative non-limiting embodiment of the invention, a groove is positioned between the first and second connectors and the side edges of the first and second body portions. The groove is designed to facilitate in the bending of the connectors along the groove when the container sleeve is formed for fitting about the beverage container. In another and/or alternative non-limiting embodiment of the invention, the top edges of the body portions are connected together by a serrated region. In another and/or alternative non-limiting embodiment of the invention, the top edges of the body portions are separated by a slot prior to when the container sleeve is formed for fitting about the beverage container. In another and/or alternative non-limiting embodiment of the invention, a majority of the top edges of the body portions are spaced apart from one another by an opening prior to when the container sleeve is formed for fitting about the beverage container. In another and/or alternative non-limiting embodiment of the invention, the opening between the top edges has a shape selected from the group consisting of a circle, an oval or polygonal shape. In another and/or alternative non-limiting embodiment of the invention, the side edges of the body portions form two slide slots when the container sleeve is connected to the container. In another and/or alternative non-limiting embodiment of the invention, the two side slots have a shape selected from the group consisting of a U-shape or V-shape. In another and/or alternative non-limiting embodiment of the invention, the first and second side edges on at least one of the body portions is tapered toward one another along a longitudinal length of the at least one body portion. In still another and/or alternative non-limiting embodiment of the invention, the container sleeve can include one or more openings positioned on or closely adjacent to said first connector, said second connector, or combinations thereof. The opening is generally positioned along a dividing axis of the container sleeve, which dividing axis is generally positioned between the top edges of the first and second body portion. The one or more openings are designed to inhibit or prevent tearing of at least one of the connectors when the container sleeve is formed for positioning about a container.

It is one non-limiting object of the present invention to provide a container sleeve for containers such as, but not limited to paper cups.

It is another and/or alternative non-limiting object of the present invention to provide a simple and inexpensive container sleeve.

It is still another and/or alternative non-limiting object of the present invention to provide a container sleeve that at least partially insulates against heat losses or heat gains.

It is yet another and/or alternative non-limiting object of the present invention to provide a container sleeve that provides an inexpensive arrangement for advertising in the form of product and/or service endorsements, competition advertising, and the like.

It is still yet another and/or alternative non-limiting object of the present invention to provide a container sleeve that thermally insulates the hand of a user from a liquid or food item in a container.

It is another and/or alternative non-limiting object of the present invention to provide a container sleeve that is formed from a single sheet.

It is still another and/or alternative non-limiting object of the present invention to provide a container sleeve that does not require an adhesive to form the container sleeve or to connect the container sleeve to a container.

It is yet another and/or alternative non-limiting object of the present invention to provide a container sleeve that does not require the ends of the sleeve to be connected to or otherwise assembled prior to using the sleeve on the container.

It is still yet another and/or alternative non-limiting object of the present invention to provide a container sleeve that inhibits or prevents tearing or ripping of one or more of the connectors when the container sleeve is formed for positioning about a container.

These and other objects and advantages will become apparent from the following description taken together with the accompanying drawings.

### BRIEF DESCRIPTION OF DRAWINGS

Reference may now be made to the drawings, which illustrate various embodiments that the invention may take in physical form and in certain parts and arrangements of parts wherein;

FIG. 1 is a front elevation view of a container sleeve in accordance with the present invention that is positioned about a container showing my new design;

FIG. 2 is a front perspective view of the container sleeve of FIG. 1;

FIG. 3 is a top plan view of the container sleeve of FIG. 1;

FIG. 4 is a left side view of the container sleeve of FIG. 1;

FIG. 5 is a right side view of the container sleeve of FIG. 1;

FIG. 6 is a top side view of the container sleeve of FIG. 1;

FIG. 7 is a bottom side view of the container sleeve of FIG. 1;

FIG. 8 is a bottom plan view of the container sleeve of FIG. 1;

FIG. 9 is a front elevation view of another configuration of a container sleeve in accordance with the present invention that is positioned about a container showing my new design;

FIG. 10 is a front perspective view of the container sleeve of FIG. 9;

FIG. 11 is a top plan view of the container sleeve of FIG. 9;

FIG. 12 is a left side view of the container sleeve of FIG. 9;

FIG. 13 is a right side view of the container sleeve of FIG. 9;

FIG. 14 is a top side view of the container sleeve of FIG. 9;

FIG. 15 is a bottom side view of the container sleeve of FIG. 9;

FIG. 16 is a bottom plan view of the container sleeve of FIG. 9;

FIG. 17 is a front elevation view of another container sleeve that is similar to FIG. 1 except that the material is a corrugated material and the connectors are folded inwardly;

FIG. 18 is a front perspective view of the container sleeve of FIG. 17;

FIG. 19 is a cross-sectional view along lines 19-19 of FIG. 18;

FIG. 20 is a front elevation view of another container sleeve that is similar to FIG. 1 except that the material is a front faced corrugated material;

FIG. 21 is a front perspective view of the container sleeve of FIG. 20;

FIG. 22 is a top plan view of the container sleeve of FIG. 20;

FIG. 23 is a left side view of the container sleeve of FIG. 20;

FIG. 24 is a right side view of the container sleeve of FIG. 20;

FIG. 25 is a top side view of the container sleeve of FIG. 20;

FIG. 26 is a bottom side view of the container sleeve of FIG. 20;

FIG. 27 is a bottom plan view of the container sleeve of FIG. 20;

FIG. 28 is a front elevation view of another container sleeve that is similar to FIG. 9 except that the material is a front faced corrugated material;

FIG. 29 is a front perspective view of the container sleeve of FIG. 28;

FIG. 30 is a top plan view of the container sleeve of FIG. 28;

FIG. 31 is a left side view of the container sleeve of FIG. 28;

FIG. 32 is a right side view of the container sleeve of FIG. 28;

FIG. 33 is a top side view of the container sleeve of FIG. 28;

FIG. 34 is a bottom side view of the container sleeve of FIG. 28; and,

FIG. 35 is a bottom plan view of the container sleeve of FIG. 28.

### NON-LIMITING DETAILED DESCRIPTION OF THE INVENTION

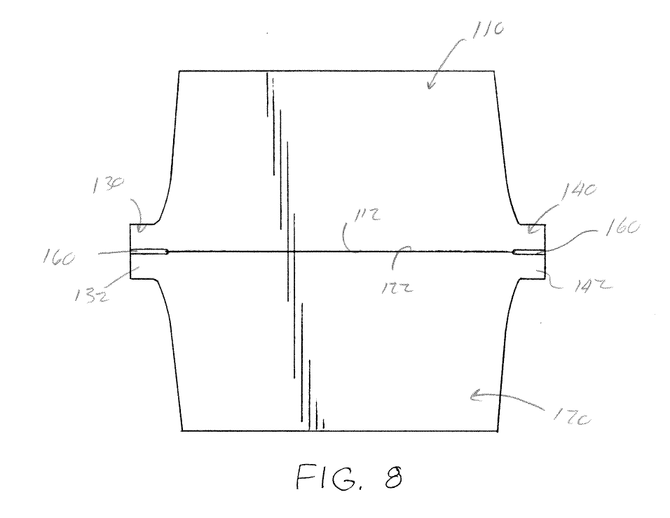

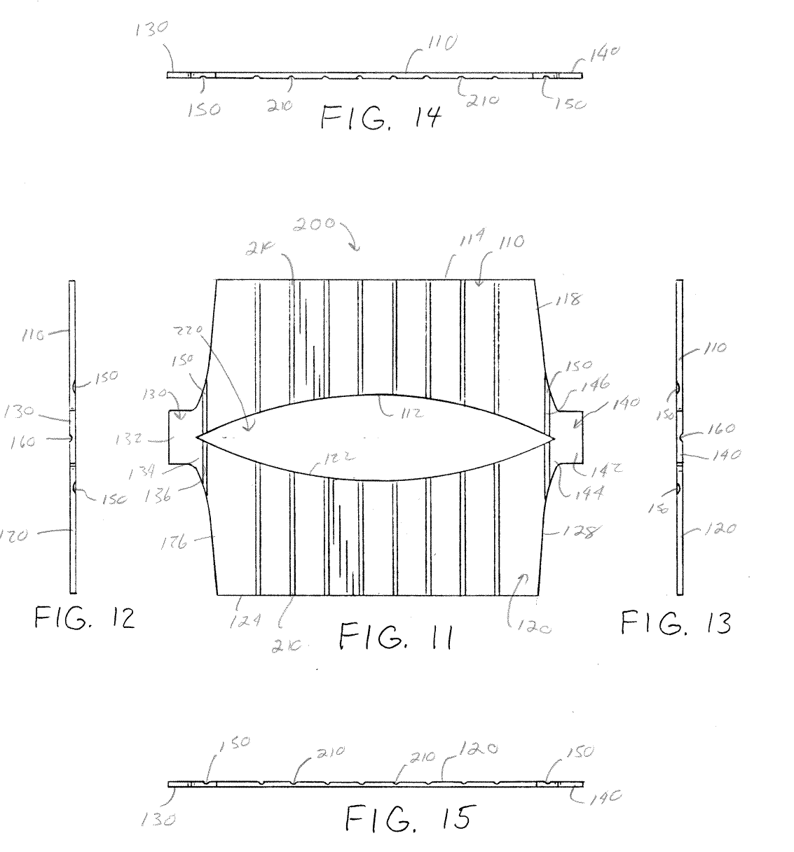

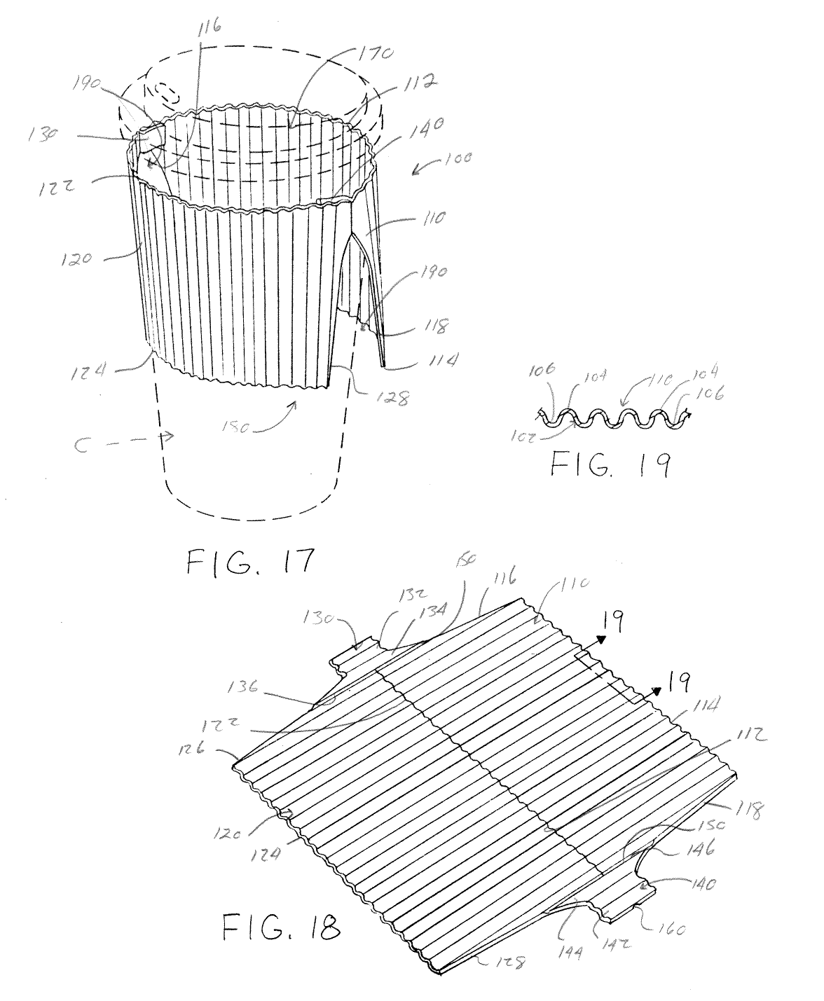

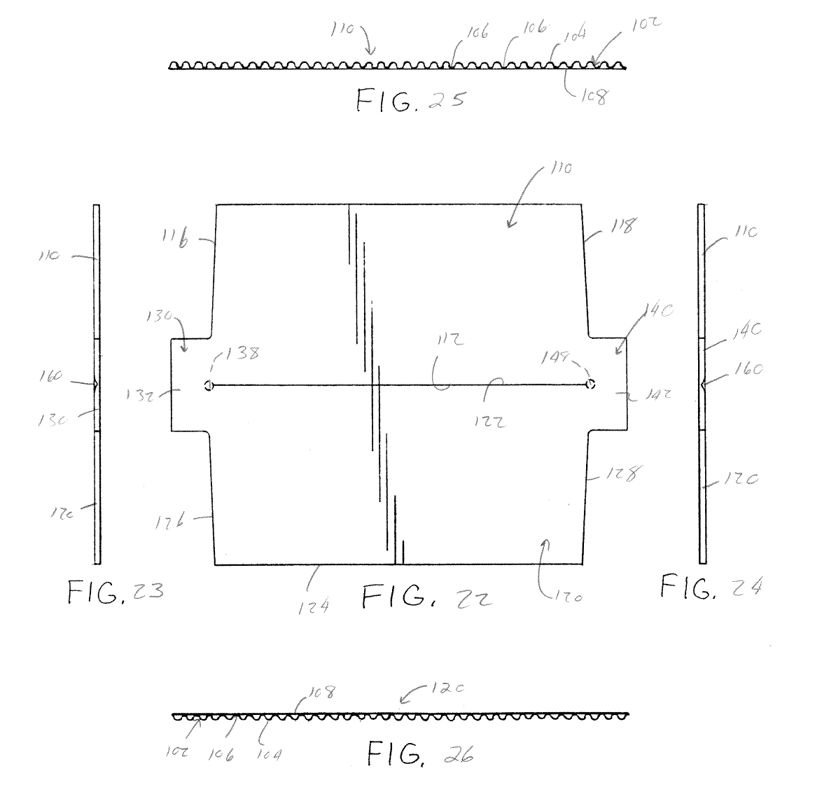

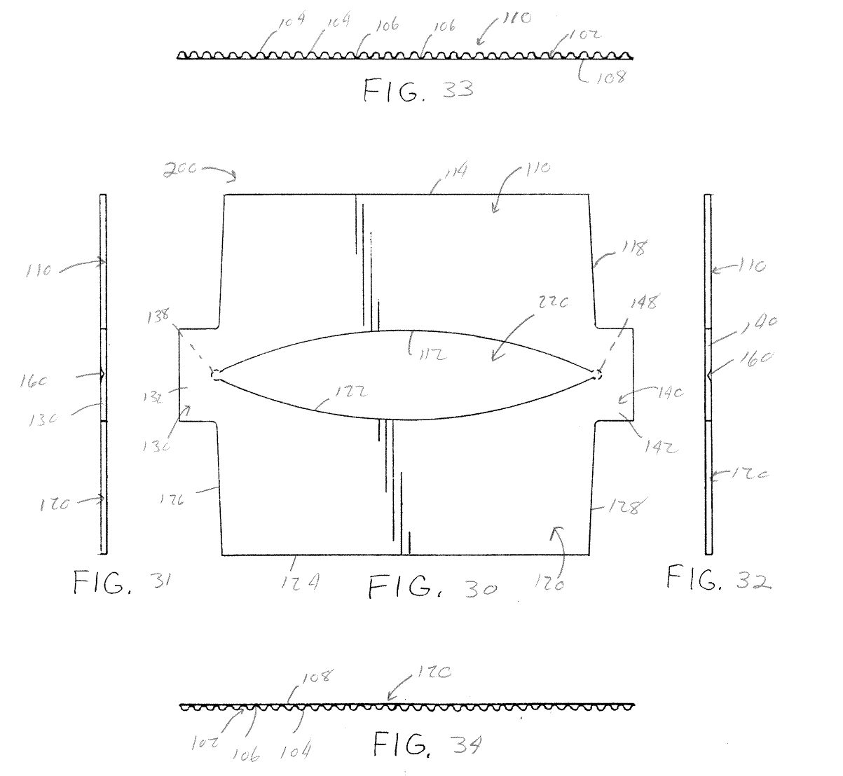

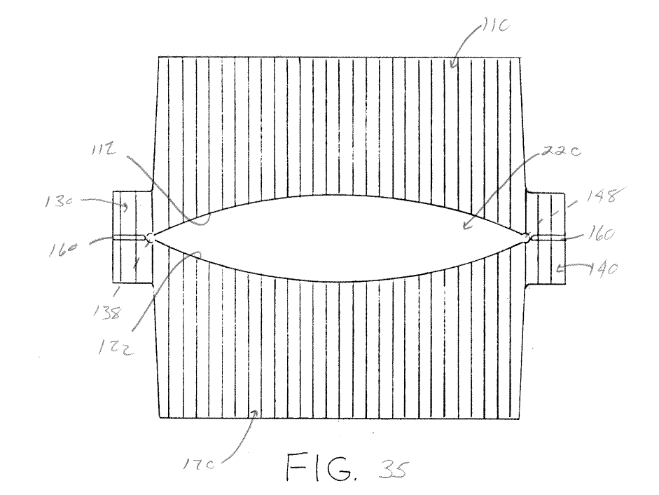

Referring now to the drawings wherein the showings are for the purpose of illustrating non-limiting embodiments of the invention only and not for the purpose of limiting same, FIGS. 1-35 illustrate two limiting embodiments of the container sleeve in accordance with the present invention. FIGS. 1-8 and 17-27 illustrated one non-limiting embodiment and FIGS. 9-16 and 28-35 illustrate a second non-limiting embodiment of the invention.

The present invention is directed to a cup sleeve, more particularly to a one-piece cup sleeve, and even more particularly to a one-piece paper cup sleeve. Although the cup sleeve is generally formed of paper (e.g., recycled paper, non-recycled paper, paper board, corrugated paper board, etc.), the cup sleeve can be formed of other materials (e.g., plastic, fabric, composite materials, etc.).

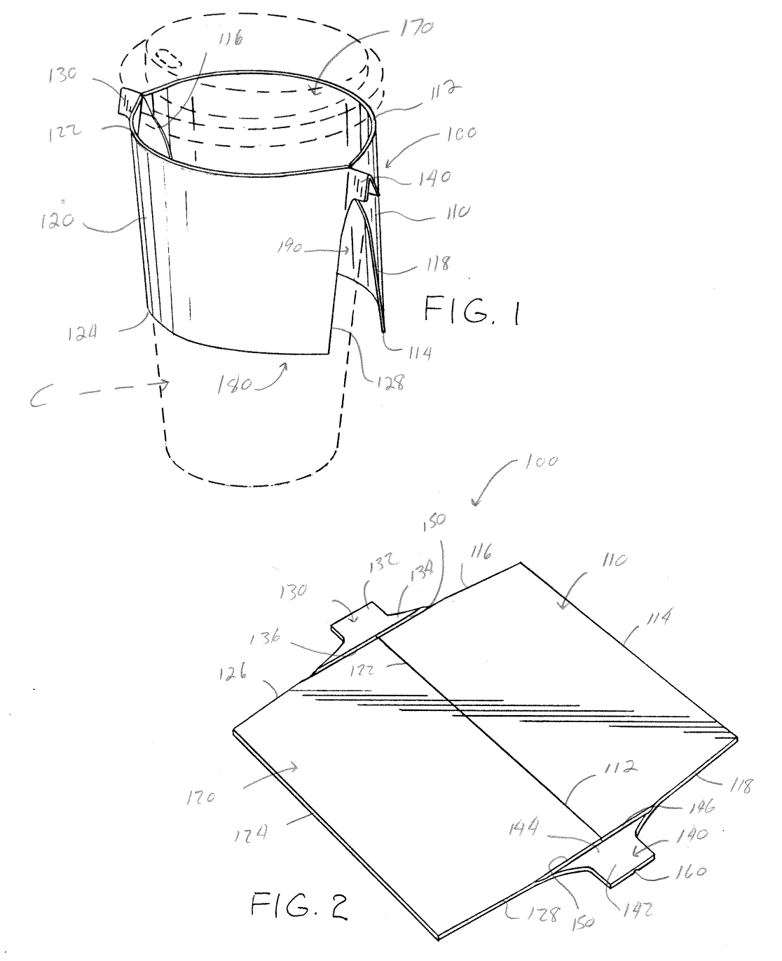

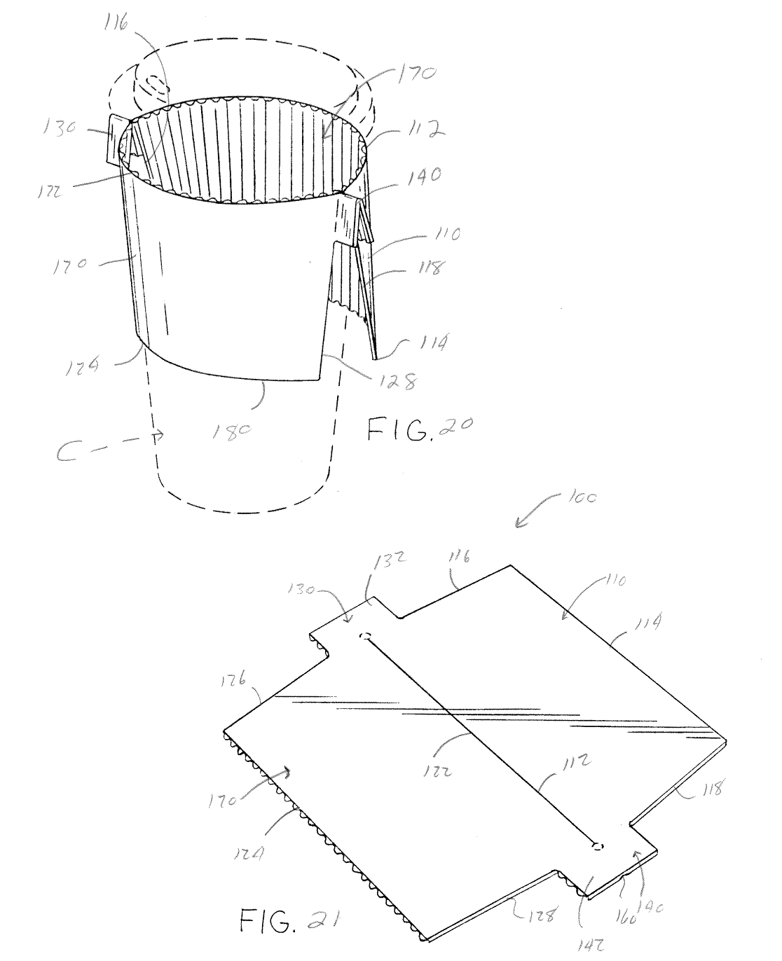

Referring now to FIGS. 1-8 and 17-27, there is illustrated a one-piece container sleeve 100 that is designed to tit about a container C. FIGS. 1, 17 and 20 illustrate the container sleeve being fitted about a container. The size of the container that can be used with the container sleeve of the present invention is non-limiting. FIGS. 2-8, 18 and 21-27 illustrate the container sleeve after it has been cut, stamped, etc. from a single piece of material such as a paper or cellulose material such as, but not limited to, a paper board material. Generally the paper or cellulose material is about 3-100 lbs. (per thousand square feet) material, typically about 5-80 lbs. (per thousand square feet) material, more typically about 10-60 lbs. (per thousand square feet) material; however; other weights of paper or cellulose material can be used. The thickness of the paper or cellulose material is generally about 0.01-0.1 inches; however, other thicknesses can be used. The cut container sleeve is illustrated as being generally flat and having a generally uniform thickness. As such, the container sleeve is easy and convenient to package after formation and takes up very little space. FIGS. 1-8 illustrate the container sleeve formed of a generally flat material such as, but not limited to, a paper board material. Both the top and bottom sides of the container sleeve are illustrated as being generally flat and planar. FIGS. 17-19 illustrate the container sleeve formed of a corrugated material 102 and include a plurality of hills 104 and valleys 106. As illustrated in FIG. 19, both sides of the container sleeve can have a corrugated surface. FIGS. 20-27 illustrate that one side of the corrugated material 102 is connected to a flat or planar piece of material 108. The bottom surface of the valleys is illustrated as being connected to the flat or planar piece of material. As can be appreciated, the top surface of the hills can also or alternatively be connected to the flat or planar piece of material. The type of material illustrated in FIGS. 20-27 is known in the art of a single face corrugated material. As can be appreciated, the material used to form the container sleeve can be a double faced corrugated material wherein a flat or planar material is connected to both sides of the corrugated material. The thickness of the corrugated material and/or the flat or planar material is non-limiting. The corrugated material and the flat or planar material can be formed of the same or different material. The corrugated material and the flat or planar material can be connected together by a variety of means (e.g., adhesive, melted seam, staple, etc.). One non-limiting material is a paper corrugated material that is connected to a flat or planar paper board material. The number of corrugated layers and/or flat and planar materials used to form the material for the container sleeve is non-limiting. As also can be appreciated, the material used to form the container sleeve can include multiple layers of material which can be the same or different (e.g., two layers of corrugated material, two layers of paper board material, one layer of paper corrugated material and one layer of paper board material, one layer of paper corrugated material and one layer of paper board material on each side of the corrugated material, etc.). The use of one or more layers of corrugated material can enhance the insulating feature of the container sleeve. Likewise, the use of one or more layers of flat or planar material with one or more layers of corrugated material can enhance the insulating feature of the container sleeve. Also, a material that is formed of a plurality of flat or planar materials can enhance the insulating feature of the container sleeve. Such improved insulation can be used to a) facilitate in reducing heat loss of the food/beverage in the container, b) facilitate in reducing heat gain of the food/beverage in the container, and/or c) reducing the exposure of a user's hand to the heat/cold of the food/beverage in the container.

The container sleeve includes a first body portion 110, a second body portion 120, a first connector 130 and a second connector 140. The first and second body portions are illustrated as having four sides and a generally rectangular shape; however, it can be appreciated that the first and second body portions can have different shapes. The size, shape and thickness of the first and second body portions is illustrated as being generally the same; however, this is not required. The first body portion includes a top edge 112, a bottom edge 114, a first side edge 116, and a second side edge 118. The second body portion includes a top edge 122, a bottom edge 124, a first side edge 126, and a second side edge 128. The width of the first and second body portions is selected to enable a user to easily grasp the body portions when the container sleeve is inserted onto the container. Generally, the width of the body portions is about 10%-100% the longitudinal length of the container. Typically, the width of the body portions is about 15%-90% the longitudinal length of the container. More typically, the width of the body portions is about 25%-90% the longitudinal length of the container. Still more typically, the width of the body portions is about 35%-90% the longitudinal length of the container. Even more typically, the width of the body portions is about 50%-90% the longitudinal length of the container. Still even more typically, the width of the body portions is about 51%-90% the longitudinal length of the container. The first and second connectors are illustrated as having the same size, shape and thickness; however, this is not required. As can be appreciated, one or both sides of the body portions can be connected together by more than one connector (e.g., 2-4 connectors on both sides, etc.). Each connector includes a top region 132, 142 and base legs 134, 144. The use of base legs on the connectors is an optional feature. As illustrated in FIGS. 21, 22 and 27, The width of the connectors is generally constant throughout the longitudinal length of the connector. The top region of each of the connectors is illustrated as being generally rectangular; however, the top region can have other shapes. The base legs of each of the connectors is illustrated as being connected to the side edges of the first and second body portions. The two legs of each of the two connectors are illustrated as angling outwardly from the top region of the connectors such that the width of the bottom of the connectors is greater than the width of the top region of the connectors. As can be appreciated, one or both connectors can have a constant width along the length of the connector (e.g., FIGS. 21, 22 and 27), or the width of the bottom of the connectors can be less than the width of the top region of one or both connectors. The bottom 136 of first connector 130 is illustrated as being connected to first side edge 116 of first body portion 110 and also to first side edge 126 of second body portion 110. The bottom 146 of second connector 140 is illustrated as being connected to second side edge 118 of first body portion 110 and also to second side edge 128 of second body portion 110.

The first and second connectors are integrally formed with the two body portions as illustrated in FIGS. 2-8, 18 and 21-27. FIGS. 4-7 and 23-26 illustrate that there is no break between the connectors and the side edges of the body portions after the container sleeve is cut, punched-out or otherwise formed from the single piece of material. As such, the first and second connectors are not subsequently connected to first or second body portions after the body portions are formed. The first and second connectors are formed from the same material as the two body portions and are generally formed at the same time as the two body portions; however, it can be appreciated that one or both of the connectors can be formed prior to or after the formation of one or both of the body portions. The first and second connectors are also not designed to be removed from the first and second body portions when forming the container sleeve for use on a container.

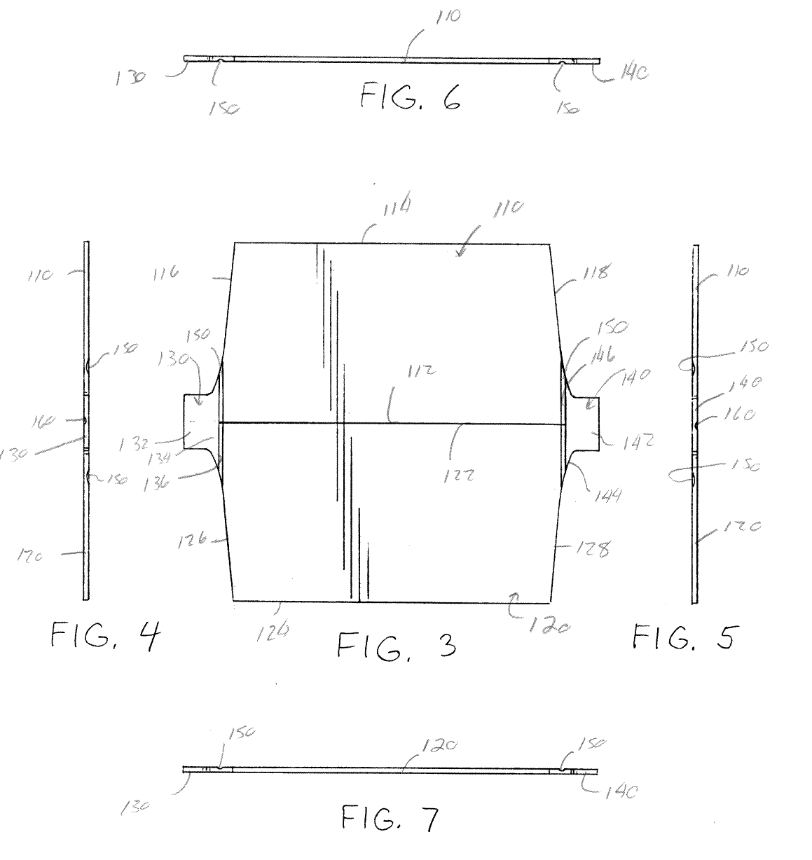

As illustrated in FIGS. 2, 18 and 21, the first connector is connected only partially along the length of the first side edges of the first and second body portions; however, it can be appreciated that the first connector can be connected along the full length of the first side edges of the first and second body portions. Likewise, the second connector is connected only partially along the length of the second side edges of the first and second body portions; however, it can be appreciated that the second connector can be connected along the full length of the second side edges of the first and second body portions. Generally, the first connector is connected to about 2%-60% of the length of the first side edge of the first body portion and 2%-60% of the length of the first side edge of the second body portion, and the second connector is connected to about 2%-60% of the length of the second side edge of the first body portion and 2%-60% of the length of the second side edge of the second body portion. Typically, the first connector is connected to about 5%-50% of the length of the first side edge of the first body portion and 5%-50% of the length of the first side edge of the second body portion, and the second connector is connected to about 5%-50% of the length of the second side edge of the first body portion and 5%-50% of the length of the second side edge of the second body portion. More typically, the first connector is connected to about 10%-40% of the length of the first side edge of the first body portion and 10%-40% of the length of the first side edge of the second body portion, and the second connector is connected to about 10%-40% of the length of the second side edge of the first body portion and 10%-40% of the length of the second side edge of the second body portion. Still more typically, the first connector is connected to about 20%-40% of the length of the first side edge of the first body portion and 20%-40% of the length of the first side edge of the second body portion, and the second connector is connected to about 20%-40% of the length of the second side edge of the first body portion and 20%-40% of the length of the second side edge of the second body portion. FIGS. 2, 18 and 21 illustrate that the first connector is connected to about 20%-35% of the length of the first side edge of the first body portion and 20%-35% of the length of the first side edge of the second body portion, and the second connector is connected to about 20%-35% of the length of the second side edge of the first body portion and 20%-35% of the length of the second side edge of the second body portion. Generally, one or both connectors are connected to generally the same amount of the side edge of one or both side edges of the first and/or second body portions. In such an arrangement, each of the connectors can be generally centered about the oppositely facing top edges of the first and second body portions; however, this is not required. FIGS. 3, 8, 22 and 27 illustrate the two connectors connected to the same amount of the side edge of both side edges of the first and second body portions such that each of the connectors are centered about the oppositely facing top edges of the first and second body portions.

As illustrated in FIGS. 3, 8, 22 and 27, the two connectors on the container sleeve extend outwardly from the side edges of the first and second body portions prior to the container sleeve being formed for fitting onto the container. Generally, the two connectors extend outwardly from the side edges of the first and second body portions a distance that is about 2%-30% the largest width of the first or second body portion. Typically, the two connectors extend outwardly from the side edges of the first and second body portions a distance that is about 4%-20% the largest width of the first or second body portion. More typically, the two connectors extend outwardly from the side edges of the first and second body portions a distance that is about 5%-15% the largest width of the first or second body portion. FIGS. 3, 8, 22, and 27 illustrate the two connectors extend outwardly from the side edges of the first and second body portions a distance of about 8%-12% the largest width of the first or second body portion. FIGS. 3, 8, 22 and 27 also illustrate that both connectors are the same shape and size. The shape and configuration of the two connectors can be used to facilitate in holding and/or gasping the container sleeve when positioned on the container, or function as a friction engagement to maintain the sleeve on a container.

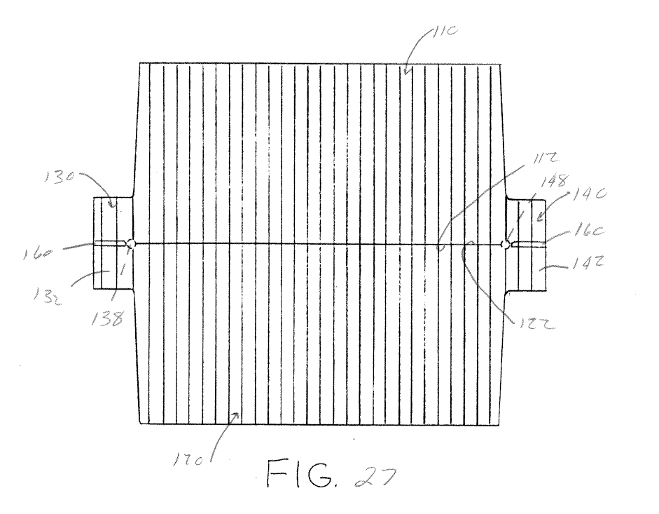

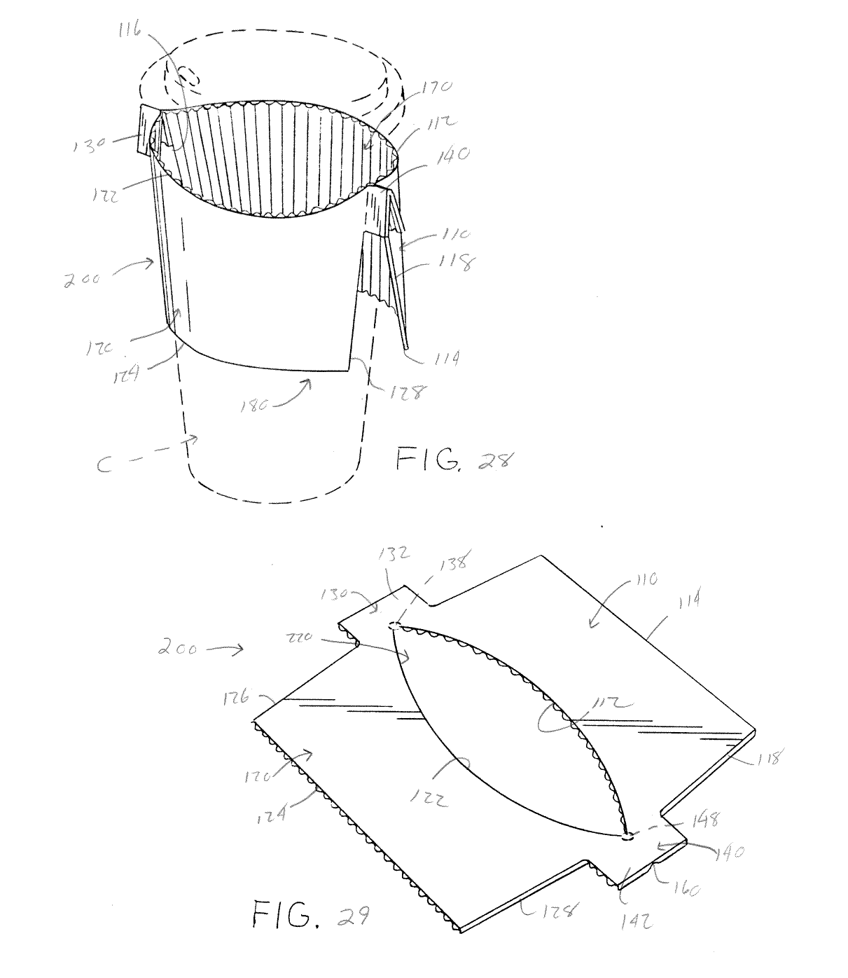

A groove 150 is illustrated as being positioned between the two bottoms 136, 146 of the connectors and the side edges of the two body portions. The inclusion of the groove is optional and is used to facilitate in the bending of the connectors relative to the body portions when the container sleeve is formed and fitted onto a container. As illustrated in FIGS. 21, 22 and 27, the container sleeve is absent such groove. FIG. 27 illustrates that the corrugated material can provide the same or similar function as the grooves in that the corrugated material can enable the connector to be folded back or bent. As can be appreciated, other or additional arrangements can be used to facilitate in the bending of the connectors (e.g., slots, serrations, notches, etc.). Also, a longitudinal groove 160 is illustrated as being positioned along the length of the connectors. The inclusion of the groove is optional and is used to facilitate in the bending of the connectors relative to the body portions when the container sleeve is formed and fitted onto a container. As can be appreciated, one or both body portions can include a groove or other type of arrangement that facilitates in the forming of the body portions when the container sleeve is formed and fitted onto a container. Non-limiting examples of such grooves are illustrated in FIGS. 9-15, 21, 23, 24 and 27, which will be described in more detail below.

A connector opening 138, 148 can be optionally positioned fully or partially in one or both of the connectors as illustrated by the dashed lines in FIGS. 22 and 27. Generally, one or both ends of the slot or serrated region that exists between the top edges terminates into the connector openings; however, this is not required. Generally, a majority of the connector opening is located within the connector and is spaced from the side edges and back edges of the connector as illustrated in FIGS. 22 and 27. Typically, at least about 75% of the connector opening is located within the connector, more typically at last about 85% of the connector opening is located within the connector, and even more typically about 90-100% of the connector opening is located within the connector. The size of the connector openings are non-limiting. As illustrated in FIGS. 22 and 27, the connector openings have a generally circular shape. The connector openings, as with top edges 112, 124, are illustrated as being aligned along the central horizontal axis of the container sleeve. The maximum cross-sectional length of the connector opening is generally less than 50% of the maximum width of the connectors, typically the maximum cross-sectional length of the connector opening is generally less than 40% of the maximum width of the connectors, more typically the maximum cross-sectional length of the connector opening is generally less than 30% of the maximum width of the connectors, and even more typically the maximum cross-sectional length of the connector opening is generally less than 20% of the maximum width of the connectors.

During the formation of the container sleeves, a serrated region or a cut region can be formed between the two front edges of the body portions so that the front edges can be separated from one another during the forming of the container sleeve for placement on the container. When the container sleeve is cut at the front edges, the cut can be fully through the material or only be partially through the material.

Referring now to FIGS. 1, 2, 17, 18, 20 and 21, the container sleeve illustrated in FIGS. 2, 18 and 21 is formed into a shape that can be placed over container C. During the formation of the container sleeve, the bottom edges 114, 124 of the two body portions are moved toward one another. During such movement, the two connectors are bent along the length of the connectors. Grooves 160 facilitate in such bending. The connectors are designed to bend, but not tear or break along the groove. During or after such bending, the top ends of the body portions are separated from one another. The connectors are designed to remain connected to the body portions. Once the front ends are separated, and the body portions are bent partially or fully together, the connectors are pushed or moved toward one another to form a generally circular or oval opening 170 in the top of the formed container sleeve as illustrated in FIGS. 1, 17 and 20. If a fully cut slot exists between top edges 112, 122, the top edges will simply separate from one another when the connectors are pushed or moved toward one another. If a slot or serration exists between top edges 112, 122, the top edges may need to be first separated from one another prior to the connectors being pushed or moved toward one another. When the connector openings are included on the container sleeve, the connector openings inhibit or prevent tearing of the connectors at or near the central horizontal axis of the container sleeve when the top edges 112, 122 are separated from one another and/or when the connectors are pushed or moved toward one another. Top edges 112, 124 form the top opening. As illustrated in FIGS. 1, 17 and 20, the two connectors are the only components of the container sleeve that maintain the two body portions together. The base of container C is designed to be inserted through opening 170 and partially fitted through the container sleeve until the diameter of the container is about the same as the minimum diameter of width of opening 170. The sliding of the container in the container sleeve can facilitate in the further forming of the container sleeve about the container; however, this is not required.

As also illustrated in FIGS. 1, 17 and 20, side edges 118, 128 are spaced apart from one another. The shape and size of the spacing can be modified by the cut of the side edges. As illustrated in FIGS. 3, 8, 22 and 27, edges 114, 124 are generally parallel to one another; however, this is not required. Such a configuration results in the bottom 180 of the formed sleeve lying in generally the same plane as illustrated in FIGS. 1, 17 and 20. Side edges 116, 118 on the first portions and side edges 126, 128 on the second portion are illustrated as tapering toward one another as illustrated in FIGS. 3, 8, 22 and 27. As can be appreciated, side edges 116, 118 on the first portions and/or side edges 126, 128 on the second portion can be parallel to one another or diverge outwardly from one another. As illustrated in FIGS. 1, 17 and 20, such tapering results in the generally U-shaped or V-shaped configuration of side slot 190 on the container sleeve. The side slot 190 narrows in width along the longitudinal length of the formed container sleeve from bottom 180 to opening 170. The base of the slot is spaced from top ends 112, 122.

As illustrated in FIGS. 1 and 20, connectors 130, 140 extend outwardly from the body portions of the container sleeve and the container C when the container sleeve is positioned on the container. The outwardly facing connectors can be used to facilitate in grasping and/or holding the container; however, this is not required.

During the formation of the container sleeve, the connectors can be folded so that one or both connectors face inwardly from the body portions and engage the container when the container sleeve is fitted onto the container as illustrated in FIG. 17. The inwardly facing connectors can be used to facilitate in maintaining the container sleeve on the container; however, this is not required. When such a connector configuration is desired, one or both connectors are folded onto the top face of the body portions along groove 150 and/or a valley region in a corrugated material. Thereafter, the container sleeve is opened as described above. Prior to the container being inserted though opening 170, the inwardly facing connectors are bent toward the inner surface of the formed container sleeve so that the base of the container can more easily be inserted through opening 170; however, this is not required.

The outer surface of one or more the body portions can include verbiage, graphics, removable coupons, texturing, etc.; however, this is not required.

Referring now to FIGS. 9-16 and 28-35, a second non-limiting embodiment of a container sleeve 200 is illustrated. The design and configuration of the container sleeve is very similar to the container sleeve illustrated in FIGS. 1-8, 17-19 and 20-27. As such, the number of similar components for the two container sleeves will be the same. Also, the operation and function of the components of container sleeve 200 will not be repeated since the operation and function of container sleeve 200 is the same or similar to the operation and function of container sleeve 100. Furthermore, the materials used to form container sleeve 200 are generally the same type of materials used to form container sleeve 100. Lastly, the reconfiguration of container sleeve 200 and the method for inserting the container sleeve on container C is the same or similar to that described above regarding container sleeve 100, thus will not be repeated herein.

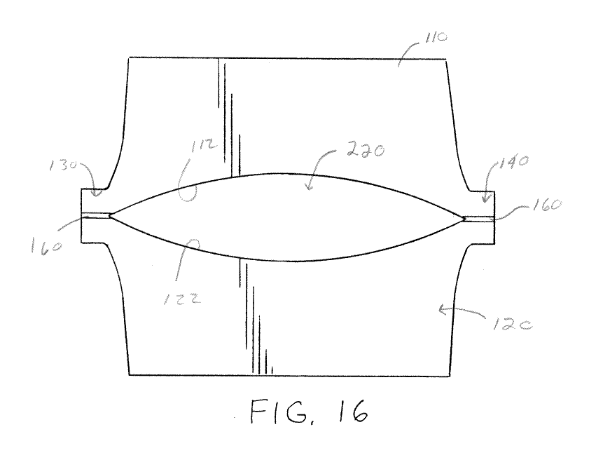

As illustrated in FIGS. 9-16, the first and second body portions include a plurality of grooves 210 on the top surface of the body portions. The grooves are designed to facilitate in the forming of the body portions around the outer surface of the container when the container sleeve is inserted on the container. The inclusion of the grooves is optional. The grooves are illustrated as running normal to the longitudinal axis of the body portions. As can be appreciated, one or more of the grooves, when used, can run in non-normal directions relative to the longitudinal axis of one or both body portions. FIGS. 28-35 illustrate the container sleeve formed of a material that is similar to the material used for the container sleeve in FIGS. 20-27. The two body portions are illustrated as including the same number of grooves; however, this is not required. Adjacently positioned grooves are illustrated as being positioned at generally equal distances from one another; however, this is not required. As illustrated in FIG. 16, one side of the body portions does not include grooves; however, it can be appreciated that one or both sides of one or both body portions can alternatively or additionally include one or more grooves, or the grooves can be absent from both sides of the body portions.

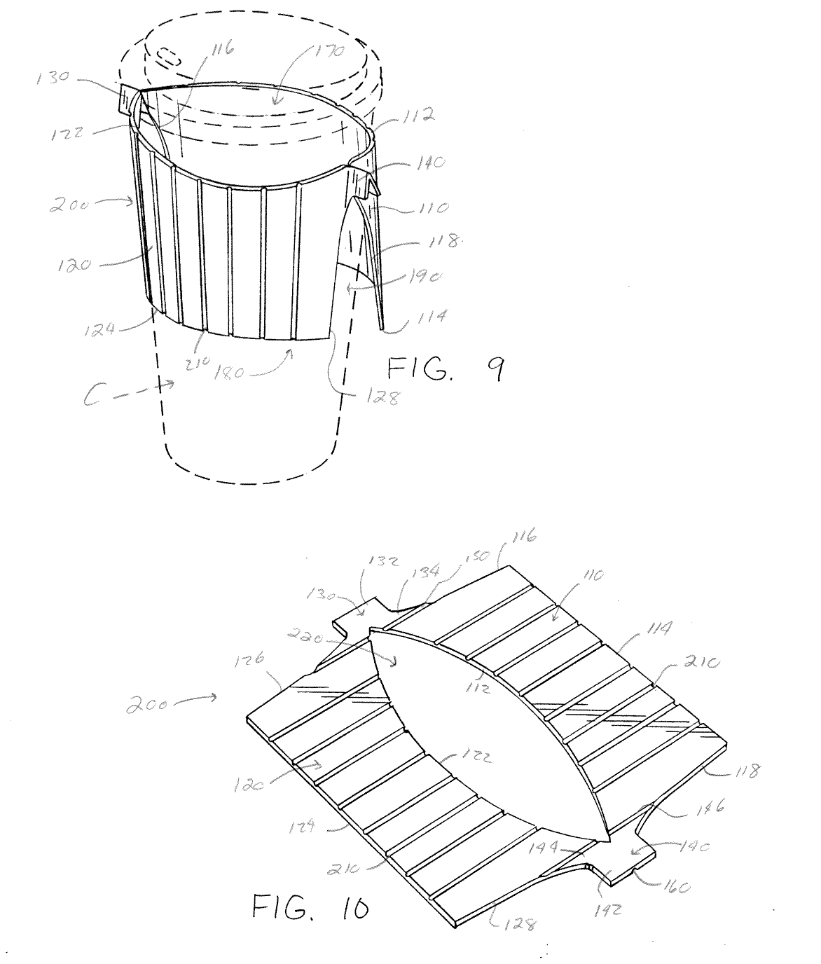

The container sleeve is illustrated in FIGS. 10, 11, 16, 29, 30 and 35 as including an oval shaped opening 220 between top edges 112, 122 of the body portions. As can be appreciated, opening 220 can have other shapes (e.g., circular, square, rectangular, other polygonal shapes, etc.). The opening can be used to facilitate in forming opening 170 when the container sleeve is formed for the container so that opening 170 better conforms to the shaped of the container. Opening 220 can also or alternatively be used to make it easier to form the container sleeve for insertion about container C. The ends of opening 220 are illustrated as partially extending into the two connectors; however, this is not required. As illustrated in FIGS. 29, 30 and 35, the ends of opening 220 terminate into connector openings 138, 148. The use of the connector openings is optional.

FIGS. 9 and 26 illustrate the connectors facing outwardly from the container. As can be appreciated, container sleeve 200 can be configured such that the connectors face inwardly similar to the connectors illustrated in FIG. 17. As can also be appreciated, the material used to form container sleeve 200 can be the same as the material illustrated and described in FIGS. 1-8 and 17-27.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween.

I claim:

1. A container sleeve designed to be fitted about a beverage container and formed of a single piece of material, said container sleeve including a first body portion, a second body portion, a first connector and a second connector, said first and second body portions including a top edge and first and second side edges, said top edges of said body portions facing one another prior to said container sleeve being formed for fitting about the beverage container, said top edges defining a top opening of said container sleeve when said container sleeve is formed for fitting about the beverage container, said first connector integrally connected to said first side edges of said first and second body portions, said second connector integrally connected to said second side edges of said first and second body portions.

2. The container sleeve as defined in claim 1, wherein only said two connectors connect together said first and second body portions.

3. The container sleeve as defined in claim 1, wherein said first and second connectors extend outwardly from said side edges of said first and second body portions.

4. The container sleeve as defined in claim 1, wherein said first and second connectors includes a groove along a longitudinal length of said connectors, said groove designed to facilitate in bending said connectors along said grooves when said container sleeve is formed for fitting about the beverage container.

5. The container sleeve as defined in claim 1, wherein said first and second body portions include a plurality of grooves that are normal to a longitudinal axis of said first and second body portions, said grooves designed to facilitate in bending said first and second body portions about the container when said container sleeve is formed for fitting about the beverage container.

6. The container sleeve as defined in claim 1, including a groove positioned between said first and second connectors and said side edges of said first and second body portions, said groove designed to facilitate in said bending of said connectors along said groove when said container sleeve is formed for fitting about the beverage container.

7. The container sleeve as defined in claim 1, wherein said top edges of said body portions are connected together by a serrated region.

8. The container sleeve as defined in claim 1, wherein said top edges of said body portions are separated by a slot prior to when said container sleeve is formed for fitting about the beverage container.

9. The container sleeve as defined in claim 1, wherein a majority of said top edges of said body portions are spaced apart from one another by an opening prior to when said container sleeve is formed for fitting about the beverage container.

10. The container sleeve as defined in claim 9, wherein said opening has a shape selected from the group consisting of a circle, an oval or polygonal shape.

11. The container sleeve as defined in claim 1, wherein said side edges of said body portions form two slide slots when said container sleeve is connected to the container.

12. The container sleeve as defined in claim 11, wherein said two side slots have a shape selected from the group consisting of a U-shape or V-shape.

13. The container sleeve as defined in claim 1, wherein said first and second side edges on at least one body portion taper toward one another along a longitudinal length of said at least one body portion.

14. The container sleeve as defined in claim 1, including an opening positioned on or closely adjacent to said first connector, said second connector, or combinations thereof, said opening positioned along a dividing axis of said container sleeve, said dividing axis positioned between said top edges of said first and second body portion, said opening designed to inhibit or prevent tearing of at least one of said connector when said container sleeve is formed for positioning about a container.

15. A container sleeve designed to be fitted about a beverage container and formed of a single piece of material, said container sleeve including a first body portion, a second body portion, a first connector and a second connector, said first and second body portions including a top edge and first and second side edges, said top edges of said body portions facing one another prior to said container sleeve being formed for fitting about the beverage container, said top edges defining a top opening of said container sleeve when said container sleeve is formed for fitting about the beverage container, said first connector integrally connected to said first sides edges of said first and second body portions, said second connector integrally connected to said second side edges of said first and second body portions, only said two connectors connect together said first and second body portions, said first and second connectors extend outwardly from said side edges of said first and second body portions, said side edges of said body portions forming two slide slots when said container sleeve is connected to the container.

16. The container sleeve as defined in claim 15, wherein said first and second connectors include a groove along a longitudinal length of said connectors, said groove designed to facilitate in bending said connectors along said grooves when said container sleeve is formed for fitting about the beverage container.

17. The container sleeve as defined in claim 15, wherein said first and second body portions include a plurality of grooves that are normal to a longitudinal axis of said first and second body portions, said grooves designed to facilitate in bending said first and second body portions about the container when said container sleeve is formed for fitting about the beverage container.

18. The container sleeve as defined in claim 15, including a groove positioned between said first and second connectors and said side edges of said first and second body portions, said groove designed to facilitate in said bending of said connectors along said groove when said container sleeve is formed for fitting about the beverage container.

19. The container sleeve as defined in claim 15, wherein a majority of said top edges of said body portions are a) connected together by a serrated region prior to when said container sleeve is formed for fitting about the beverage container, b) separated by a slot prior to when said container sleeve is formed for fitting about the beverage container, or c) spaced apart from one another by an opening prior to when said container sleeve is formed for fitting about the beverage container, opening having a shaped selected from the group consisting of a circle, an oval or polygonal shape.

20. The container sleeve as defined in claim 15, wherein said two side slots have a shape selected from the group consisting of a U-shape or V-shape.

21. The container sleeve as defined in claim 15, wherein said first and second side edges on at least one body portion tapers toward one another along a longitudinal length of said at least one body portion.

22. The container sleeve as defined in claim 15, including an opening positioned on or closely adjacent to said first connector, said second connector, or combinations thereof, said opening positioned along a dividing axis of said container sleeve, said dividing axis positioned between said top edges of said first and second body portion, said opening designed to inhibit or prevent tearing of at least one of said connectors when said container sleeve is formed for positioning about a container.
